(19) United States
(12) Patent Application Publication
(10) Pub. No.: US 2007/0085664 A1
(43) Pub. Date: Apr. 19, 2007

(54) Frequency Hopping System and Method for Communicating with RFID Tags

(76) Inventors: Vijay Pillai, Mukilteo, WA (US); Rene D. Martinez, Seattle, WA (US); Shashi Ramamurthy, White Plains, NY (US); David Lee Eastburn, Cedar Rapids, IA (US)

Correspondence Address: JOHN H. SHERMAN, LEGAL DEPT.;INTERMEC TECHNOLOGIES CORPORATION, 550 2ND STREET SE, CEDAR RAPIDS, IA, 52401, US

(21) Appl. No.: 11/465,788

(22) Filed: Aug. 18, 2006

Related U.S. Application Data
(63) Continuation-in-part of application No. 10/814,411, filed on Mar. 30, 2004, now Pat. No. 7,103,087.
(63) Continuation-in-part of application No. 10/779,320, filed on Feb. 12, 2004.
(60) Provisional application No. 60/459,414, filed on Mar. 31, 2003.

(51) Int. Cl. H04Q 5/22

(52) U.S. Cl. 340/10.34

(57) ABSTRACT

Radio frequency (RF) power is sent out by a base station to radio frequency identification transponders (RFID tags) for a first time at a first frequency. The frequency is changed to a second frequency, and the RF power sent out for a second time substantially different from the fist time so as to tend to improve data throughput. In one embodiment forced frequency “hops” are implemented if the time it takes to perform a particular transaction is greater than the time available on a particular carrier frequency. In one embodiment, a radio frequency identification (RFID) base station processor (in conjunction with program information stored in a base station memory) is adapted to (i) determine the amount of time available on a particular carrier frequency (e.g., pursuant to Federal Communications Commission (FCC) regulations, European Telecommunications Standardization Institute (ETSI) regulations, etc.), (ii) determine the amount of time it would take to perform a particular transaction, and (iii) force the base station to “hop” to another carrier frequency if the transaction time is longer than the available time. In one embodiment, the time it would take to perform a particular transaction is the time it would take to perform the next transaction. In another embodiment, the time it would take to perform a particular transaction is the time it would take to perform the longest (or “worst-case”) transaction. In alternate embodiments, a transaction is defined as the transmission of information (e.g., data, commands, etc.) or both the transmission of information and the reception of related information.

### FIELD OF THE INVENTION

The field of the invention is the field of radio frequency (RE) identification (RFID) transponders (tags), and systems for their use.

### BACKGROUND OF THE INVENTION

RF Transponders (RF Tags) can be used in a multiplicity of ways for locating and identifying accompanying objects and transmitting information about the state of the object. It has been known since the early 60's in U.S. Pat. No. 3,098,971 by R. M. Richardson, that electronic components of transponders could be powered by radio frequency (RF) electromagnetic (EM) waves sent by a “base station” and received by a tag antenna on the transponder. The RF EM field induces an alternating current in the transponder antenna which can be rectified by an RF diode on the transponder, and the rectified current can be used for a power supply for the electronic components of the transponder. The transponder antenna loading is changed by something that was to be measured, for example a microphone resistance in the cited patent. The oscillating current induced in the transponder antenna from the incoming RF energy would thus be changed, and the change in the oscillating current led to a change in the RF power radiated from the transponder antenna. This change in the radiated power from the transponder antenna could be picked up by the base station antenna and thus the microphone would in effect broadcast power without itself having a self contained power supply. The “rebroadcast” of the incoming RF energy is conventionally called “back scattering”, even though the transponder broadcasts the energy in a pattern determined solely by the transponder antenna. Since this type of transponder carries no source of energy of its own, it is called a “passive” transponder to distinguish it from a transponder containing a battery or other energy supply, conventionally called an active transponder. The power supply of the passive transponder is typically a capacitor which is charged by rectifying the RF power signal sent out by the base station, but may be any source of power which is energized by an external signal.

Active transponders with batteries or other independent energy storage and supply means such as fuel cells, solar cells, radioactive energy sources etc. can carry enough energy to energize logic, memory, and tag antenna control circuits. However, the usual problems with life and expense limit the usefulness of such transponders.

In the 70's, suggestions to use backscatter transponders with memories were made. In this way, the transponder could not only be used to measure some characteristic, for example the temperature of an animal in U.S. Pat. No. 4,075,632 to Baldwin et. al., but could also identify the animal.

The continuing march of semiconductor technology to smaller, faster, and less power hungry has allowed enormous increases of function and enormous drop of cost of such transponders. Presently available research and development technology will also allow new function and different products in communications technology. However, the new functions allowed and desired consume more and more power, even though the individual components consume less power.

It is thus of increasing importance to be able to power the transponders adequately and increase the range which at which they can be used. One method of powering the transponders suggested is to send information back and forth to the transponder using normal RF techniques and to transport power by some means other than the RF power at the communications frequency. However, such means require use of possibly two tag antennas or more complicated electronics.

Sending a swept frequency to a transponder was suggested in U.S. Pat. No. 3,774,205. The transponder would have elements resonant at different frequencies connected to the tag antenna, so that when the frequency swept over one of the resonances, the tag antenna response would change, and the backscattered signal could be picked up and the resonance pattern detected.

Prior art systems can interrogate the tags if more than one tag is in the field. U.S. Pat. No. 5,214,410, hereby incorporated by reference, teaches a method for a base station to communicate with a plurality of tags.

Sending at least two frequencies from at least two antennas to avoid the “dead spots” caused by reflection of the RF was proposed in EPO 598 624 A1, by Marsh et al. The two frequencies would be transmitted simultaneously, so that a transponder in the “dead spot” of one frequency would never be without power and lose its memory of the preceding transaction.

The prior art teaches a method to interrogate a plurality of tags in the field of the base station. The tags are energized, and send a response signal at random times. If the base station can read a tag unimpeded by signals from other tags, the base station interrupts the interrogation signal, and the tag which is sending and has been identified, shuts down. The process continues until all tags in the field have been identified. If the number of possible tags in the field is large, this process can take a very long time. The average time between the random responses of the tags must be set very long so that there is a reasonable probability that a tag can communicate in a time window free of interference from the other tags.

In order that the prior art methods of communicating with a multiplicity of tags can be carried out, it is important that the tags continue to receive power for the tag electronics during the entire communication period. If the power reception is interrupted for a length of time which exceeds the energy storage time of the tag power supply, the tag “loses” the memory that it was turned off from communication, and will restart trying to communicate with the base station, and interfere with the orderly communication between the base station and the multiplicity of tags.

The amount of power that can be broadcast in each RF band is severely limited by law and regulation to avoid interference between two users of the electromagnetic spectrum. For some particular RF bands, there are two limits on the power radiated. One limit is a limit on the continuously radiated power in a particular bandwidth, and another limit is a limit on peak power. The amount of power that can be pulsed in a particular frequency band for a short time is much higher than that which can be broadcast continuously.

Federal Communications Commission Regulation 15.247 and 15.249 of Apr. 25, 1989 (47 C.F.R. 15.247 and 15.249) regulates the communications transmissions on bands 902-928 MHZ, 2400-2483.5 MHZ, and 5725-5850 MHZ. In this section, intentional communications transmitters are allowed to communicate to a receiver by frequently changing frequencies on both the transmitter and the receiver in synchronism or by “spreading out” the power over a broader bandwidth. The receiver is, however, required to change the reception frequency in synchronism with the transmitter.

### RELATED PATENTS AND APPLICATIONS

The following U.S. Patents and patent applications are assigned to the assignee of the present invention: U.S. Pat. Nos.: 6,320,896, 6,327,312, 6,005,530, 6,122,329, 6,501,807, 6,294,997, 6,166,638, 6,441,740, 6,104,291, 5,939,984, 6,140,146, 6,259,408, 6,236,223, 6,249,227, 6,201,474, 6,100,804, 6,294,996, 6,486,769, 6,121,880, 6,518,885, 6,593,845, 6,320,509, 6,639,509, 5,485,520, 6,275,157, 6,285,342, 6,366,260, 6,215,402, 6,118,379, 6,177,872, 6,281,794, 6,130,612, 6,147,606, 6,288,629, 6,172,596, 6,566,850, 6,535,175; 5,850,181; 5,828,693; 6,404,325; 6,812,841; 6,122,329; published Patent Application US 2005-0253687, and U.S. patent applications Ser. No. 09/394,241 filed Sep. 13, 1999, Ser. No. 10/056,398 filed Jan. 23, 2002, Ser. No. 10/662,950 fled Sep. 15, 2003,+and 60/459,414 filed Mar. 31, 2003. The above patents and patent applications are hereby incorporated by reference.

### OBJECTS OF THE INVENTION

It is an object of the invention to produce a method, an apparatus, and a system communicating between a base station and at least one tag which decreases the time taken to identify the tag or tags.

### SUMMARY OF THE INVENTION

Information is communicated between a base station and at least one tag by sending RF power Pⱼ for a first time tⱼ to the tag at a first frequency fⱼ from the base station to the tag, then sending power for a second time tₖ to the tag at a second frequency fₖ, where tⱼ and tₖ are substantially different times.

### BRIEF DESCRIPTION OF THE DRAWINGS

FIG. 1A is the power and FIG. 1B is the frequency transmitted as a function of time in the prior art.

FIG. 2A is the power and FIG. 2B is the frequency transmitted as a function of time in one of the preferred methods of the invention.

FIG. 3 is block diagram of a preferred method of the invention.

FIG. 4 is a conceptual block diagram of a RFID system including a base station and an RFID tag;

FIG. 5 further illustrates the RFID base station depicted in FIG. 4;

FIG. 6 is a flow chart illustrating one embodiment of the present invention; and

FIG. 7 is a flow chart illustrating another embodiment of the present invention

### DETAILED DESCRIPTION OF THE INVENTION

U.S. Pat. No. 5,828,693 to Mays, et al. issued Oct. 27, 1998 entitled Spread spectrum frequency hopping reader system and U.S. Pat. No. 5,850,181 to Heinrich, et al. issued Dec. 15, 1998 entitled Method of transporting radio frequency power to energize radio frequency identification transponders, assigned to the assignee of the present invention, give details on RFID tags powered by an RF field where the frequency sent to the tags hops from frequency to frequency chosen from a pseudorandomly ordered list of frequencies. In both the above described patents, the RF field is sent out to the tags from a base station as a series of bursts of power at a particular frequency, with the frequency changing for the next burst, but the power and the length of time of the bursts are kept constant. U.S. Pat. No. 5,828,693 teaches that the length of time of each burst the regular series of bursts may be changed to avoid having one or more base stations interfering with one another. Apparatus and methods for changing the frequency and the power sent out by the tags are well described in these patents. The above patents are hereby incorporated by reference.

In a preferred communication between a base station and a group of tags, each tag is identified, and then instructed to take no further part in the communication unless it is called upon to do so by calling its identification number. Since two tags “talking” at the same time to the base station will interfere with each other, a tag which has once been identified, and which loses its “memory” that it was identified, will slow the communication with the group down because it will have to be re-identified and re-instructed to keep silence. In the U.S. Pat. No. 5,850,181 referred to above, the importance of keeping the tag functional by not allowing the power in the tag to drop below a minimum was pointed out. In a preferred embodiment, well described in copending application Ser. No. 10/056398 assigned to the assignee of the present invention filed Jan. 23, 2002 by Heinrich et al., power is provided for a long time to to just one device or function on the tag . . . the device or “flag” which tells the tag that it has been identified. A separate power supply such as a capacitor is provided which provides power only to the flag for a time t₀ long compared to the normal tag power down time when all the tag electronics are drawing current (which could be as short at 50 microsee). Such a situation may occur, for example, when the frequency sent to the tag changes, and the tag is in a position where multipath effects drop the power received by the already identified tag below that power which the tag needs to be fully functional. If the tag flag remains set until the frequency is changed again and the multipath transmission changes so the tag is powered once again, the tag remembers that it has been identified, and does not interrupt communications by trying to contact the base station. The above application Ser. No. 10/056398 is hereby incorporated by reference.

When a group of tags is being interrogated by a base station, the base station according to the prior art sends out signals at a frequency fᵢ for a fixed time tᵢ, and then changes frequency to another frequency fⱼ chosen from a list of frequencies listed in pseudorandom order, and then sends frequency fⱼ for the same time tᵢ. This process is continued until all tags have been identified. It may be, however, that the base station sends out a command for unidentified tags in the field to respond, and no tags respond, either because all tags in the field have been identified or because some tags in the field do not receive power because of the above identified multipath problems. Presently, the base station continues to send power at the same frequency and power for the same amount of time regardless of whether a tag in the field responds. The base station continues through the pseudorandomly ordered list of frequencies, and either stops transmission or starts again at the beginning of the list. U.S. Pat. No. 5,828,693 mentions that the amount of time that a base station sends out a particular frequency before the frequency changes may be changed, but does not state conditions for such changes. In particular, U.S. Pat. No. 5,828,693 does not specify that the length of time taken to change the time interval shall be less than the time taken to power down the tag or the time for the flag to reset.

In the most preferred method of the present invention, the base station changes frequency as soon as no tags respond, so that those unidentified tags which are silent because they are in a multipath power minimum at frequency fⱼ will see a different frequency fⱼ₊₁, for which the multipath minima are in a different spatial positions. For example, at 2.4 GHz, the frequency might be changed in the prior art every 300 or 400 msec. However, the base station can tell if one or more tags is responding in as little as 10 ms. Thus, the base station will change frequencies in as little as 10 or 20 ms as soon as no more tags respond. Preferably, when the time is changed from a time tⱼ to another time tⱼ₊₁, tⱼ₊₁ will be less than tⱼ/2. More preferably, tⱼ₊₁ will be less than tⱼ/4, and most preferably tⱼ₊₁ will be less than tⱼ/10. To take into account that tⱼ₊₁ may also be longer than tⱼ, preferably ξtⱼ₊₁−tⱼξ>0.05 (tⱼ+tⱼ₊₁), more preferably ξtⱼ₊₁−tⱼξ>0.1 (tⱼ+tⱼ₊₁) and most preferably ξtⱼ₊₁−tⱼξ>0.3 (tⱼ+tⱼ₊₁).

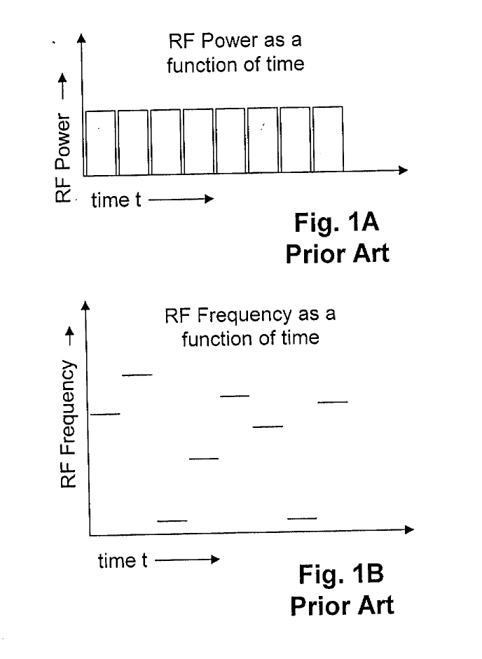

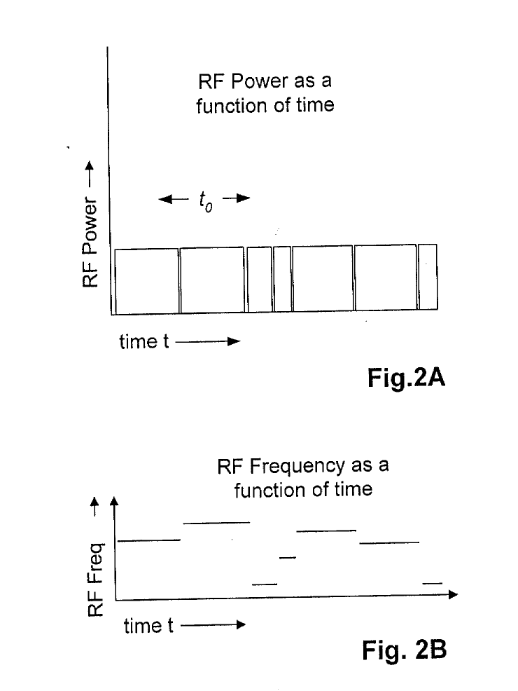

FIG. 1A and 1B show the prior art sent out RF power and frequency as a function of time. The frequency is changed at regular times, and the power is greatly reduced as the frequency is changed. FIG. 2A shows a sketch of RF power as a function of time for the method of the invention. After sending out a power Pᵢ at a frequency fᵢ for a time tᵢ, the frequency is changed and a new frequency chosen in order from a list of frequencies listed in pseudorandom order. Instead of sending a new frequency fⱼ for the same time tᵢ, the frequency fⱼ is sent out for a time tⱼ which is substantially different from tᵢ. The time taken to change the frequency from fᵢ to fⱼ and the timing from tᵢ to tⱼ must be less than the time t₀ for the tag flag to be reset, and is preferably less than the time taken for the tag to power down once the RF field drops to zero. While the power levels sent out in FIG. 2A are shown to be constant with time, the invention anticipates that the power level sent out may change as a function of time. The power level may be an increasing or decreasing stairstep function, or indeed any regular function of time.

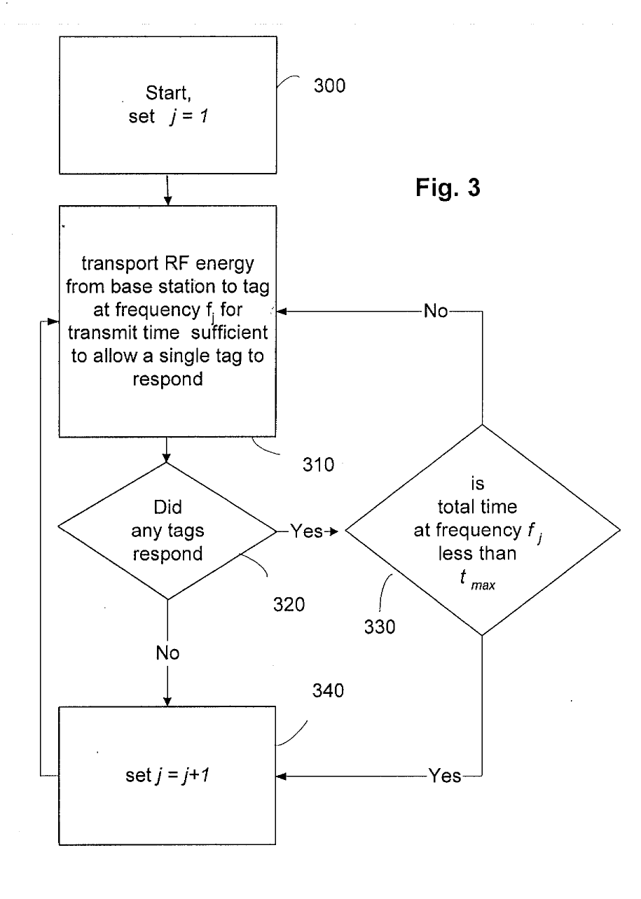

FIG. 3 shows a block diagram of the most preferred method of the invention. The base station starts by choosing the first frequency in the ordered list and sets j=1 in step 300. Then, the base station sends out RF energy a frequency fⱼ for a time sufficient for a single tag to respond in step 310. In decision step 320, the base station decides whether one or more tags responded. If one or more tags responded, another decision step 320 decides whether the total time tⱼ spent sending out frequency fⱼ exceeds a maximum time limit tₘₐₓ for sending out a single frequency at the power sent. Government regulations prohibit power of over a certain limit being sent out for more than a defined time. The protocol sets a maximum time limit tₘₐₓ (which may optionally depend on power sent out) for sending out one frequency, and when that time limit has been exceeded, the index j is changed to j+1 in step 340, and the system returns to step 310 to send out another the next frequency fⱼ₊₁ in the lists. If no tags responded in step 320, the system goes immediately to step 340 and to change frequency to the next frequency fⱼ₊₁ in the list.

In the most preferred method of the invention, the maximum time tₘₐₓ for sending out a single frequency may be reached while the first frequency is being sent out, since there are many unread tags in the field. Eventually, however, most tags have been read, and at that time, no tags return signals before the maximum time tₘₐₓ has been reached. Then, the base station cycles through the remaining frequencies in the list, or the base station decides that all tags have been identified, and starts the remainder of the protocol for communicating with the tags. It is anticipated by the inventors that the time for sending out the frequency fⱼ₊₁ in the list of frequencies could in fact be longer than the time for sending out the prior frequency fⱼ, as new tags could move into the field during the communication procedure.

It is anticipated by the inventors that the base station could send out various power levels during the communication, since fewer tags would be in effective communication with the base station if the sent out power was lower, and hence the fewer tags could be identified rapidly. Then, the power could be raised to “catch” more of the tags in the field. Alternatively, the power could be sent out high at first, and if more than one tag responds the power could be reduced to reduce the number of tags in effective communication with the base station.

### INCORPORATION BY REFERENCE

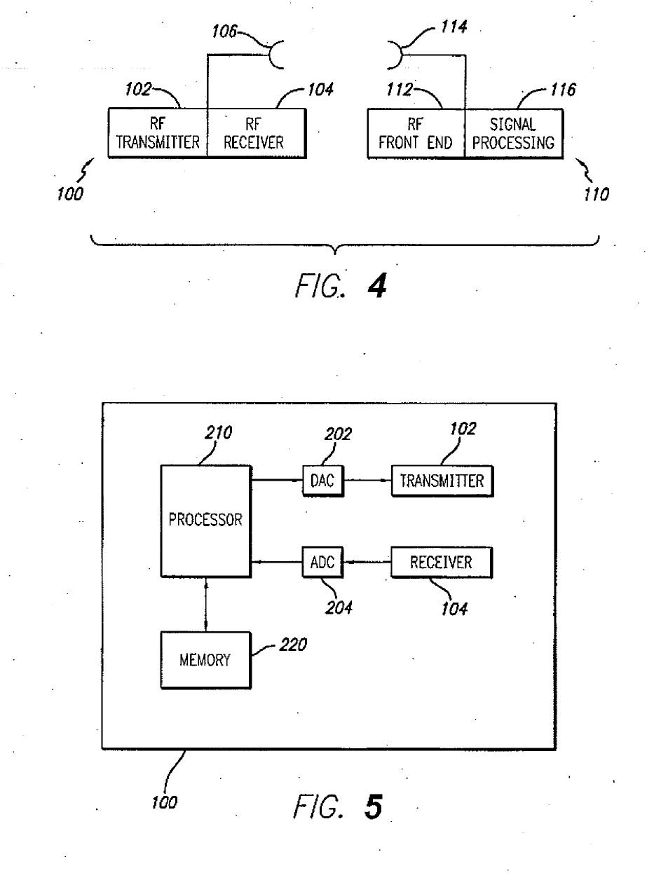

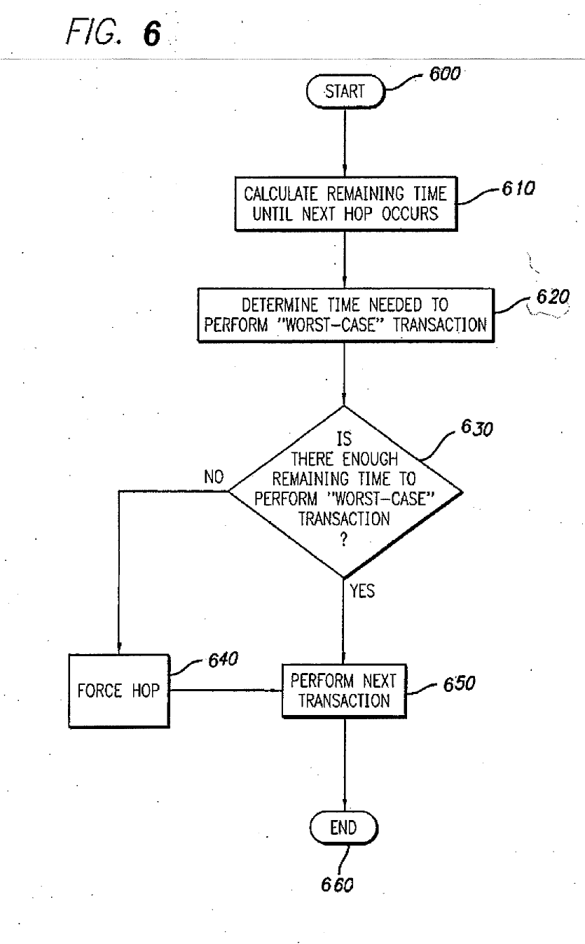

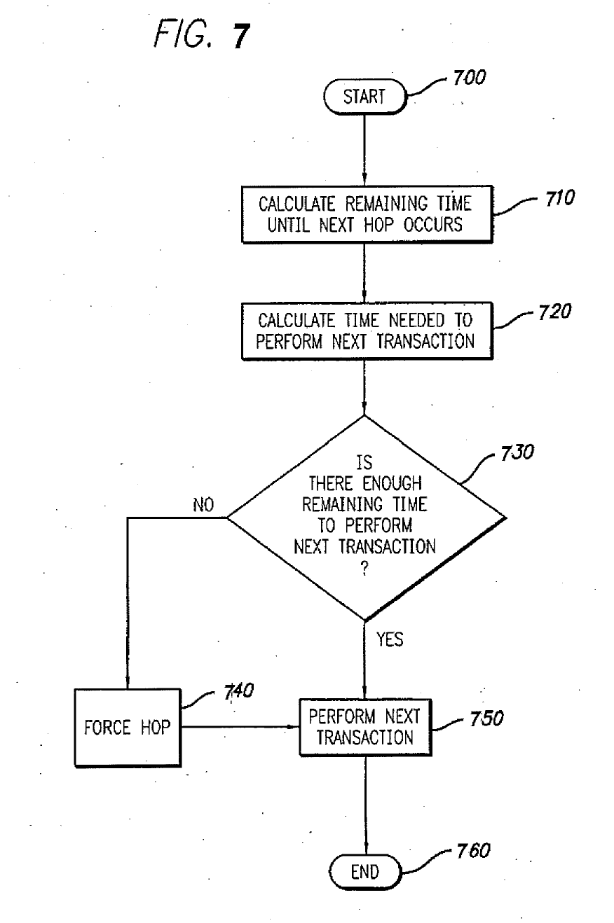

The description of FIGS. 4-7 is found as the description of figures one through four, respectively, of the incorporated David Lee Eastburn published patent application US 2004-0189443.

### Supplemental Disclosure

Title:

A protocol driven frequency hopping technique

### General Description

Typical frequency hopping is done at fixed time intervals; this has the disadvantage that tags that were in middle of the identification protocol may no longer be powered at the new frequency and thus creates an overhead coming from re-identification in the subsequent identification loop. The new technique will prevent this from happening by making sure that identifying all the tags at the current frequency before moving onto a new frequency, thus significantly improving the efficiency of the identification protocol especially with a large number of tags.

Tags lose power in the middle of the protocol and have to be re-identified, thus degrading the efficiency of the prototol; this new technique avoids this by making sure that the frequency hop is done only after all tags that are energized at a particular frequency are filly identified.

### Description

In 802.11 based frequency hopping systems, both the base station and the end terminal should know precisely what the frequency hopping pattern is, since the end terminal has to look for a signal at the specified frequency. However in RFID based frequency hopping systems, the end terminal is a power detector and has no way of knowing what the transmitted frequency (the transmitted frequency should be within the receive band of the RFID tag)—therefore there is no need for a precise frequency hopping pattern as long as sufficient frequency diversity is provided as per FCC guidelines

Typical frequency hop systems hop after a fixed amount of time has elapsed; this has the problem that tags that are currently being identified may loose power at the next frequency and the identification loop has to be started all over again—A secondary problem is that of tags that were fully identified loosing power and subsequently being re-identified along with the tags that were not identified before—this can be avoided by using the group_select_flags family of commands (this command uses a non-volatile memory on the chip that flags that it has been identified before and so there is no need to take part in the protocol loop again). And the current invention can prevent tags that were in the middle of identification from loosing power.

The point at which the hop is to happen will be when all the tags that are powered have been identified; at the next frequency, tags that were identified fully but lost power can be prevented from being re-identified using the group_select_flags family of commands. At the next frequency, since majority of the tags were already identified, a considerably less time need to be spent at this frequency; as a result the reader can scan through all permissibly frequency channels much faster so as to identify quickly weakly powered tags that are functional only at one frequency.

It is anticipated that the following would be a typical scenario where there are a few tags at the edge of the field (so tags may be powered only at one or two frequencies):

WITHOUT PROTOCOL DRIVEN FREQUENCY HOPPING

| Frequency | F1 | F2 | F3 | F4 | F5 |
|---|---|---|---|---|---|
| Time spent | 100 ms | 100 ms | 100 ms | 100 ms | 100 ms |
| Tags | 2 | 1 | 2 | 1 | |
| identified | | | | | |
| Total time | 100 ms | 200 ms | 300 ms | 400 ms | 500 ms |

WITH PROTOCOL DRIVEN FREQUENCY HOPPING

| Frequency | F1 | F2 | F3 | F4 | F5 |
|---|---|---|---|---|---|
| Time spent | 20 ms | 10 ms | 20 ms | 10 ms | |
| Tags | 2 | 1 | 2 | 1 | |
| identified | | | | | |
| Total time | 20 ms | 30 ms | 50 ms | 60 ms | |

Thus comparing the case with and without protocol driven frequency hopping, the times would be expected to be respectively 60 ms and 400 ms, clearly showing the expected advantage of protocol driven frequency hopping.

FCC Regulations and Power Budget

In practice FCC regulations do not permit staying at one particular frequency for long periods of time. There is a maximum period of time that is permitted; in order to go beyond the maximum permitted period of time (tmax), the power radiated should be reduced i.e the power time budget has to stay constant (P×t); reducing the power unfortunately may unpower a lot of RFID tags resulting in reduced throughput. As an alternative, fixed time intervals could be used in the early phases of the protocol; as soon as a majority of tags are identified, one could use protocol-driven frequency hopping (PDFH); using PDFH towards the end of the identification cycle, means that fewer tags have to be identified and as a result the time spent at each frequency could be less than tmax.

### SUMMARY

Using fixed time intervals for frequency hopping is disadvantageous for RFID based systems. Instead the time spent at each frequency should be related to the protocol; in other words the protocol decides the point of frequency hopping (in conjunction with FCC regulations) resulting in an “adaptive frequency hop pattern”; one example (not the only one) of the frequency hopping point would be when the base station has detected that there are no more tags to be identified at that particular frequency.

The following is from the incorporated David Lee Eastburn published patent application US 22 2004-01894431 A1:

A system and method is provided for implementing forced frequency “hops” if the time it takes to perform a particular transaction is greater than the time available on a particular carrier frequency. In one embodiment of the present invention, a radio frequency identification (RFID) base station processor (in conjunction with program information stored in a base station memory) is adapted to (i) determine the amount of time available on a particular carrier frequency (e.g., pursuant to Federal Communications Commission (FCC) regulations, European Telecommunications Standardization Institute (ETSI) regulations, etc.), (ii) determine the amount of time it would take to perform a particular transaction, and (iii) force the base station to “hop” to another carrier frequency if the transaction time is longer than the available time. In one embodiment of the present invention, the time it would take to perform a particular transaction is the time it would take to perform the next transaction. In another embodiment of the present invention, the time it would take to perform a particular transaction is the time it would take to perform the longest (or “worst-case”) transaction. In alternate embodiments of the present invention, a transaction is defined as the transmission of information (e.g., data, commands, etc.) or both the transmission of information and the reception of related information.

U.S. Provisional Application No. 60/459,414 filed Mar. 31, 2003 is hereby incorporated herein by reference.,

The present invention relates to a frequency hopping spread spectrum (FHSS) scheme for radio frequency identification (RFID) devices, and more particularly to a system and method for improving transmission rates in an RFID device by implementing forced frequency “hops.”

### SUMMARY OF THE INVENTION

The present invention provides a system and method for improving transmission rates in RFID base stations by implementing forced frequency “hops.” In a preferred embodiment of the present invention, the RFID base station is adapted to calculate whether the next transaction can be performed over the current carrier frequency or whether a “hop” to a new carrier frequency should be forced. More particularly, in one embodiment of the present invention, a base station processor (in conjunction with program information stored in a base station memory) is adapted to (i) determine the amount of time available on a particular carrier frequency (e.g., pursuant to FCC regulations, European Telecommunications Standardization Institute (ETSI) regulations, etc.), (ii) determine the amount of time it would take to perform a particular transaction, and (iii) force the base station to “hop” to another carrier frequency if the transaction time is longer than the available time. Such a system improves transmission rates by forcing a “hop,” as opposed to dwelling, when the transaction time is longer than the available time. In one embodiment of the present invention, the time it would take to perform a particular transaction is the time it would take to perform the next transaction. In another embodiment of the present invention, the time it would take to perform a particular transaction is the time it would take to perform the longest (or “worst-case”) transaction.

A more complete understanding of the system and method for improving transmission rates in RFID base stations by implementing forced frequency “hops” will be afforded to those skilled in the art, as well as a realization of additional advantages and objects thereof, by a consideration of the detailed description of the preferred embodiment which is incorporated herein by reference. Reference should be made to the description of FIGS. 4-7 of the appended sheets of drawings which description has been incorporated herein by reference.

### INCORPORATION BY REFERENCE OF TECHNICAL PAPER INTENDED FOR PUBLICATION

The following technical paper which has been prepared with the intention of submitting the same for publication, entitled “A Technique for Simultaneous Multiple Tag Identification”, is hereby incorporated herein by reference in its entirety.

### FURTHER INCORPORATION BY REFERENCE

U.S. Pat. No. 4,888,591, now assigned to the assignee of the present application, is hereby incorporated by reference in its entirety. This patent shows hardware circuitry, which while not preferred, is an example of circuitry that can change phase, and could be utilized for employing respective phases (e.g. estimated as explained herein), for multiple tag responses to extract or eliminate a plurality of tag responses within e.g. the time interval when a given frequency of a reader utilizing frequency hop transmission is being transmitted to the tags, and prior to transmission of the next hop frequency Examples of readers utilizing frequency hop transmission while conforming to Federal Communications Commission regulations, are found in US patent publications US 2005/0179521 published Aug. 18, 2005, and US 2004/0189443 published Sep. 30, 2004, both assigned to the assignee of the present application, and both of which are hereby incorporated herein by reference in their entirety.

Obviously, many modifications and variations of the present invention are possible in light of the above teachings. It is therefore to be understood that, within the scope of the appended claims, the invention may be practiced otherwise than as specifically described.

1-20. (canceled)

21. A radio frequency identification (RFID) system, comprising: an RFID base station adapted to communicate with at least one RFID transponder; said RFID base station comprising: a transmitter adapted to transmit radio frequency (RF) signals to said at least one RFID transponder; a receiver adapted to receive RF signals backscattered from said at least one RFID transponder; and a processor electrically connected to said transmitter and said receiver, and adapted to: determine the amount of time available on a first carrier frequency; determine the amount of time it would take to perform a particular transaction; and change to a second carrier frequency before said amount of time available on said first carrier frequency expires if said amount of time on said first carrier frequency is less than said amount of time it would take to perform said particular transaction.

22. The RFID system of claim 21, wherein said particular transaction further comprises a next transaction, such that said processor is adapted to determine the amount of time it would take to perform said next transaction.

23. The RFID system of claim 21, wherein said particular transaction further comprises a worst-case transaction, such that said processor is adapted to determine the amount of time it would take to perform the longest possible transaction.

24. The RFID system of claim 21, wherein said particular transaction further comprises a worst-case transaction, such that said processor is adapted to determine the amount of time it would take to perform the longest possible transaction with said at least one RFID transponder.

25. The RFID system of claim 21, wherein said particular transaction is a transmission of a particular RF signal, such that said processor is adapted to determine the amount of time it would take to transmit said particular RF signal.

26. The RFID system of claim 21, wherein said particular transaction is both a transmission of a particular RF signal and an expected reception of a particular RF signal in response thereto, such that said processor is adapted to determine the amount of time it would take to transmit said particular RF signal and the expected amount of time it would take to receive said particular RF signal in response thereto.

27. The RFID system of claim 21, further comprising said at least one RFID transponder.

28. The RFID system of claim 21, wherein said RFID base station further comprises a memory device electrically connected to said processor, wherein said memory device is adapted to store at least partial program information as to when said processor should hop to a different carrier frequency.

29. The RFID system of claim 21, further comprising a digital-to-analog (D/A) converter, said D/A converter electrically connecting said processor to said transmitter.

30. The RFID system of claim 28, further comprising an analog-to-digital (A/D) converter, said A/D converter electrically connecting said processor to said receiver.

31. The RFID system of claim 21, further comprising a transceiver, said transceiver comprising said transmitter and said receiver.

32. A method for improving transmission rates in a radio-frequency-identification (RFID) base station, comprising: performing a first transaction with at least one RFID transponder over a first carrier frequency; during a first time interval, transmitting a second carrier frequency for a second time interval, and controlling the duration of the second time interval to be greater or less than said first time interval so as to tend to increase data throughput.

33. The method of claim 32, further comprising the step of determining the amount of time it would take to perform a particular.

34. The method of claim 33, wherein said step of determining the amount of time it would take to perform a particular transaction further comprises determining the amount of time it would take to perform a worst-case transaction, said worst-case transaction being the longest transaction that can be performed by said RFID base station

35. The method of claim 33, wherein said step of determining the amount of time it would take to perform a particular transaction further comprises determining the amount of time it would take to perform a worst-case transaction, said worst-case transaction being the longest transaction that can be performed by said RFID base station and with said at least one RFID transponder.

36. The method of claim 33, wherein said step of determining the amount of time it would take to perform a particular transaction further comprises determining the amount of time it would take to transmit a particular radio frequency (RF) signal.

37. The method of claim 33, wherein said step of determining the amount of time it would take to perform a particular transaction further comprises determining the amount of time it would take to transmit a particular radio frequency (RF) signal and an amount of time that it might take to receive a responsive RF signal from said at least one RFID transponder.

38. The method of claim 36, wherein said step of performing a first transaction with at least one RFID transponder further comprises transmitting a first RF signal to said at least one RFID transponder, said first RF signal and said particular RF signal each comprising information selected from a list of information consisting of commands and data.

39. The method of claim 32, further comprising the step of determining the amount of time available on said first carrier frequency and comparing the amount of time that the RFID base station has continuously been on said first carrier frequency to an amount of time permitted by the Federal Communications Commission (FCC).

40. The method of claim 39, wherein said step of determining the amount of time it would take to perform a particular transaction with said at least one RFID transponder is performed prior to said step of determining the amount of time available on said first carrier frequency.

41. A frequency-hopping-spread-spectrum (FHSS) method for use in a radio-frequency-identification (RFID) device, comprising: transmitting a first radio frequency (RF) signal over a first carrier frequency for a first time period; transmitting a second RF signal over said first carrier frequency; and transmitting a second RF signal over a second carrier so as to tend to improve data throughput.

42. The FHSS method of claim 41, further comprising the step of determining the amount of time it would take to transmit a particular RF signal and further comprising determining the amount of time it would take to transmit said second RF signal.

43. The FHSS method of claim 41, further comprising the step of determining the amount of time it would take to transmit a particular RF signal and further comprising determining the amount of time it would take to transmit an RF signal having the longest transmission time of any RF signal that might be transmitted by said RFID device.

44. The FHSS method of claim 41, further comprising the step of determining the amount of time it would take to receive a modulated RF signal, said steps of transmitting a second RF signal further comprise: transmitting a second RF signal over said first carrier frequency if said amount of time available on said first carrier frequency is greater than the product of the amount of time it would take to transmit said particular RF signal and the amount of time it would take to receive said modulated RF signal; and transmitting a second RF signal over said second carrier frequency if said amount of time available on said first carrier frequency is less than the product of said amount of time it would take to transmit said particular RF signal and said amount of time it would take to receive said modulated RF signal.

45. The FHSS method of claim 44, wherein said steps of determining amounts of time it would take to transmit a particular RF signal and receive a modulated RF signal further comprise: determining the amount of time it would take to transmit an RF signal having the longest transmission time of any RF signal that might be transmitted by said RFID device; and determining the amount of time it might take to receive a modulated RF signal in response to transmitting said RF signal having the longest transmission time.
